(19) United States
(12) Patent Application Publication
(10) Pub. No.: US 2010/0114643 A1
(43) Pub. Date: May 6, 2010

(54) METHOD AND SYSTEM FOR IMPROVED SCHEDULING OF PERFORMANCES IN A DIGITAL CINEMA SYSTEM

(76) Inventors: William Gibbens Redmann, Glendale, CA (US); James Paul Sabo, Sunland, CA (US)

Correspondence Address: Robert D. Shedd, Patent Operations;THOMSON Licensing LLC, P.O. Box 5312, Princeton, NJ, 08543-5312, US

(21) Appl. No.: 12/452,257

(22) PCT Filed: Aug. 30, 2007
(86) PCT No.: PCT/US2007/019179

§ 371 Date: Dec. 22, 2009

Related U.S. Application Data
(60) Provisional application No. 60/958,637, filed on Jul. 5, 2007.

(51) Int. Cl. G06Q 10/00; G06F 17/00; G06N 5/02

(52) U.S. Cl. 705/9; 700/94; 706/47; 705/10

(57) ABSTRACT

The presentation start times of digital cinema presentations can be controlled by a method initiated by first matching a delay condition to at least one of a set of rules specifying presentation start time adjustments for the digital cinema presentations for particular delay conditions. The presentation start times in the digital cinema system then undergo an adjustment in accordance with the at least one rule matching the delay condition. The digital cinema presentations are then played out at the adjusted presentation start times.

### CROSS-REFERENCE TO RELATED APPLICATIONS

This application claims priority under 35 U.S.C. 119(e) to U.S. Provisional Patent Application Ser. No. 60/958,637, filed Jul. 5, 2007, the teachings of which are incorporated herein.

### TECHNICAL FIELD

This invention relates to a technique for scheduling content for playout in a digital cinema system.

### BACKGROUND ART

Many motion picture exhibitors employ a point-of-sale (POS) ticketing system, such as that manufactured by Radiant Systems of Alpharetta, Ga., among others. Typical POS ticketing systems rely on previously established schedules to advertise presentation start times in various media including newspapers and web sites. An exhibitor who anticipates a higher-than-planned demand for a particular feature presentation might choose to exhibit that feature presentation in one or more additional auditoriums, or move that feature to a larger auditorium, or both. Other feature presentations previously scheduled for exhibition will undergo a corresponding displacement, in terms of their exhibition venue. A motion picture exhibitor could also change the exhibition times of other feature presentations, or even cancel one or more presentations.

Advance knowledge of a planned shift of feature presentations permits the exhibitor to enter the new venues and/or start times into the POS system. After the entry of such information into the POS system, subsequently printed tickets should bear updated time and/or venue information. Likewise, automated digital signage systems controlled by the POS system should now display the title of the feature presentation(s) and start times at the appropriate venue(s). The automated digital cinema equipment system should also receive the updated feature presentation start times and/or locations to enable updating of the scheduling information as well as any necessary relocation and/or replication of content. The updated schedule information thus allows the automated digital cinema system to employ the scheduled start times for playing out (e.g., exhibiting) the feature presentations in their respective venues. Motion picture exhibitors want their automated digital cinema systems to automatically commence exhibition of the feature presentations at their respective start times as listed in the published schedule to avoid customer complaints.

Systems for initiating playout of feature presentations on a schedule include those proposed by Hose et al., (U.S. Pat. No. 6,829,033) and by Bubie et al. (U.S. Pat. No. 6,812,994). Each of these patents discloses building an initial schedule that can undergo subsequent manual editing, Ultimately, playout of the feature presentation(s) occurs according to the schedule. However, in some circumstances, commencing playout at the published start times proves problematic and some form of manual override becomes necessary. Such circumstances can include a delay due to inclement weather causing audiences to arrive at the theater late, long queues at the concession stand, a need for cleanup in an auditorium, or an equipment repair such as a lamp replacement for example.

The Hose '033 patent, incorporated by reference herein, suggests the possibility of manually pausing an in-progress playout of a feature presentation. However, an exhibitor might prefer to delay the playout of a feature presentation, or at least the actual presentation element on a play list that also includes auxiliary content, such as announcements and short segments of upcoming movies, usually referred to as “trailers.” If the feature presentation or auxiliary content should undergo a delay after the execution of the play list, desirably, the auxiliary content should undergo a continuous playout. For that reason, many exhibitors keep a quantity of auxiliary content in reserve or will play a loop of auxiliary content, to fill this gap.

Further, whether the start of the entire feature presentation, (the actual presentation and auxiliary content) undergoes a delay, or additional content undergoes playout to delay the actual presentation or the exhibitor initiates a manual pause, commencing playout of the remaining content after the delay might impact subsequently scheduled shows in the same auditorium. For instance, if the currently scheduled feature presentation undergoes a delay by 15 minutes due to a projector lamp replacement, then that presentation will end 15 minutes later than originally scheduled.

Whether and how subsequent presentations become affected should remain the choice of the exhibitor and will likely be subject to a defined policy. Likely choices include: (1) canceling the delayed show and keeping subsequent shows exactly on schedule; (2) commencing playout of the delayed feature presentation and likewise delaying all subsequent feature presentations by the same delay interval; (3) playing out the delayed feature presentation and delaying each subsequent feature presentation by no more than the minimum interval necessary to clean the theater and thereafter seat patrons (or just seat patrons), (4) playing out the delayed feature presentation but canceling any subsequent feature presentation impacted by the delay. Other choices could exist as well. Each such choice can represent a scramble for a projectionist and/or theater manager who must now take the digital cinema system out of a ‘scheduled’ mode and operate it in a ‘manual’ mode. Further, editing the presentation schedule becomes problematic since the schedule is tied to newspaper ads, movie time web sites, and issued tickets.

Thus a need exists for a technique for controlling start times of digital cinema presentations that overcomes the aforementioned disadvantages.

### BRIEF SUMMARY OF THE INVENTION

Briefly, in accordance with a preferred embodiment of the present principles, there is provided a method of controlling presentation start times of digital cinema presentations. The method includes matching a disruption condition, corresponding to a delay or excess demand, to at least one of a set of rules specifying presentation start time adjustments for the digital cinema presentations for particular disruption conditions, The presentation start times in the digital cinema system then undergo an adjustment in accordance with the at least one rule matching the disruption condition. The digital cinema presentations are then played out at the adjusted presentation start times.

### BRIEF DESCRIPTION OF THE DRAWINGS

FIG. 1 depicts a block schematic diagram of an exemplary digital cinema theater system for practicing the present principles;

FIG. 2 depicts a set of doublets, each doublet depicting a pair of time lines showing the timing of each of two feature presentations for a disruption particular condition;

FIG. 3 depicts a pair exemplary dialog displays, each prompting an action in response to a particular status condition;

FIG. 4A depicts, in flow chart form, a process for updating a presentation start time schedule;

FIG. 4B depicts, in flow chart form, a process for reacting to an unscheduled delay; and

FIG. 5 depicts a pair of doublets, the first associated with the playout of each of two feature presentations according to an initial presentation schedule, and the second showing a subsequent modification resulting from adding a playout of a feature presentation to accommodate excess demand.

### DETAILED DESCRIPTION

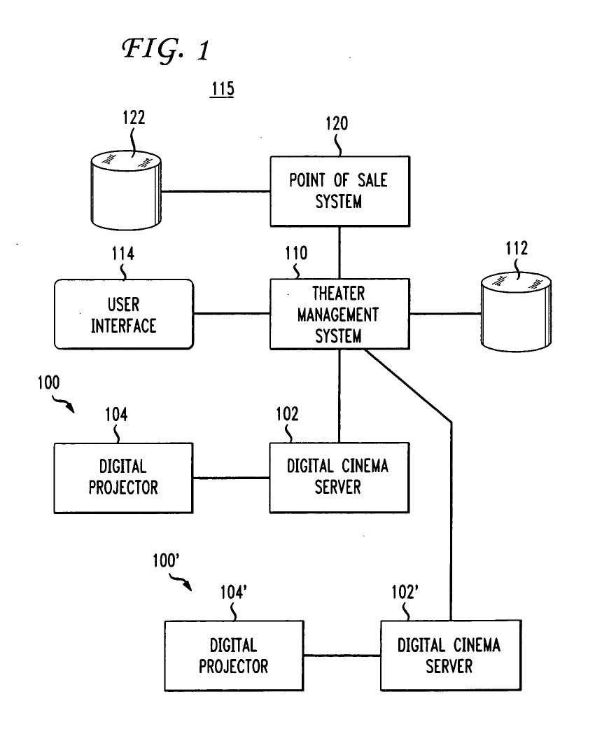

FIG. 1 depicts an exemplary digital cinema system for practicing the presentation start time control technique of the present principles that enables dynamic re-scheduling, either manually, or automatically, in an organized manner in the event of a disruption condition caused for examined by delay or excess demand. As seen in FIG. 1, the digital cinema system includes two auditoriums (e.g., exhibition venues) 100 and 100′, although the technique of the present principles could handle re-scheduling for a multiplicity of auditoriums. The auditoriums 100 and 100′ include digital projectors 104 and 104′, respectively, each controlled by a separate one of digital cinema server 102 and 102′, respectively. In addition, each auditorium includes associated audio equipment, a projection screen, and a theater automation system, all known in the art and therefore omitted from FIG. 1 for purposes of simplicity.

Each of the digital cinema servers 102 and 102′ typically takes the form of a well known digital cinema server, such as those available Dolby Laboratories, San Francisco Calif., Doremi Digital Cinema, Burbank Calif. and Eastman Kodak, Rochester, N.Y., among others. Each digital cinema server includes a decoding module (not shown) responsive to a theater management system 110. The theater management system 110 includes a computer (not shown) programmed with software for accepting one or more presentation start time schedules and for monitoring and controlling the digital cinema servers 102 and 102′ to playout digital cinema content according to a working presentation start time schedule. In practice, the working presentation start time schedule resides in a database 112 associated with the theater management system 110.

The theater management system 110 receives commands and provides status information through at least one user interface 114. In a preferred embodiment, the user interface 114 comprises a web browser running on a processor (not shown) having an associated monitor, mouse, and keyboard or touch screen (not shown). The processor communicates with theater management system 110, which provides a monitoring and control interface through an http service. Further, the user interface 114 is preferably implemented as an application written in Flash™ software available from Adobe Systems of San Jose, Calif. wherein the web browser downloads the user interface application to communicate with theater management system 110 to obtain access to monitoring and control information therefrom. Alternatively, the user interface 114 could comprise a monitor, mouse, and keyboard or touchscreen (not shown) connected directly to the theater management system 110. Further, the user interface 114 could comprise a Personal Data Assistant, or other mobile data terminal, linked to the theater management system 110 via a wireless connection.

Preferably, theater management system 110 enjoys a communication link to a Point of Sale (POS) system 120 responsible for issuing tickets to theater patrons and for tracking ticket sales. The POS system 120 has access to a database 122 that stores one or more published start time schedules among other information. Different schedules could exist for different days of the week, or a single schedule could exist for a set period of time (e.g., a week, a month etc.) Personnel at the theater can locally create each presentation start time schedule or can receive such information from a remote source, for example, the theater circuit head office.

The Theater Management System 110 maintains the working schedule(s) in the database 112. The active working presentation start time schedule initially will coincide with the published presentation start time schedule for the same time period. Heretofore, no significant difference existed between the published presentation start time schedule and working presentation start time schedule used to operate the theater. However, the introduction of a manual override of automatic presentation playouts as contemplated by the present principles and the commensurate changes to events scheduled for subsequent execution requires retention of such data in addition to the published schedule. In an illustrative embodiment of the present principles, this data constitutes the working presentation start time schedule (as contrasted by the published presentation start time schedule). However, those skilled in the art will recognize that retaining data representative of delays would allow calculation of the working presentation start schedule or portion of interest thereof on demand from the published presentation start time schedule. Thus, no need exists to continuously maintain the working presentation start time schedule to practice the present principles.

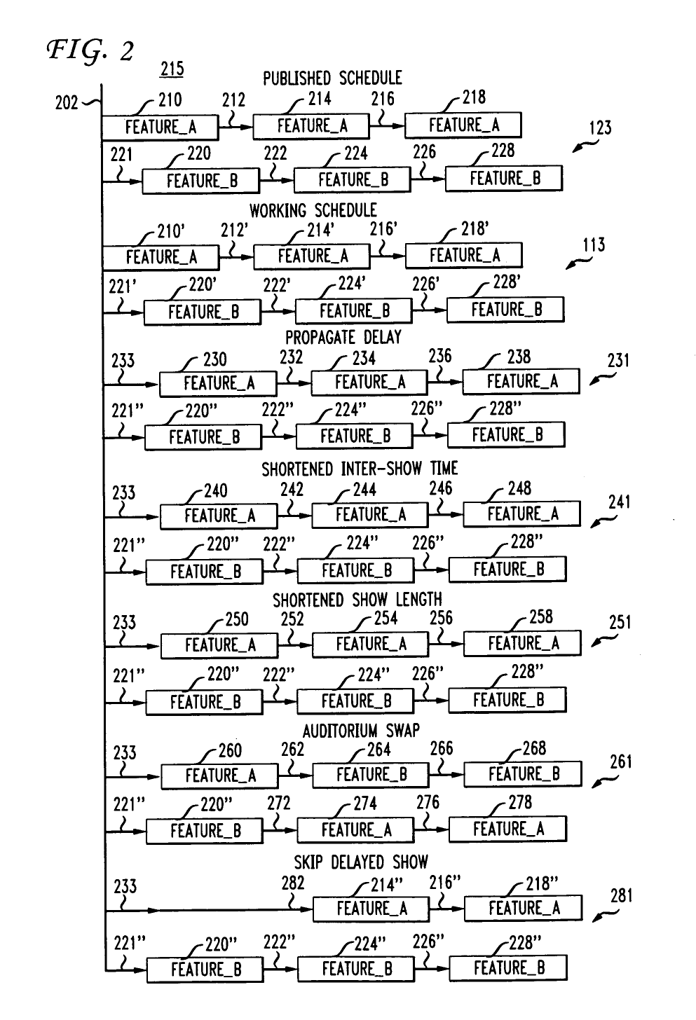

FIG. 2 depicts a set of time line pairs, hereinafter referred to as “doublets” that show the presentation start times for each of two feature presentations, designated as Feature_A and Feature_B, respectively, under various conditions. The first doublet of FIG. 2, bearing the reference number 123 corresponds to the upper-most and second upper-most time lines and depicts the published presentation start time schedule for Feature_A and Feature_B in auditoriums 100 and 100′, respectively of FIG. 1. As a matter of movie theater policy, the actual start time for the feature presentation might not coincide the with the published start time. For instance, a delay of twenty minutes might exist between the start time for a feature presentation (including auxiliary content preceding the actual presentation) and the published presentation start time. Throughout FIG. 2, time increases to the right.

Line 202 represents a particular time selected to coincide with the published start time 210 of the first playout of Feature_A scheduled to occur in the auditorium 100 of FIG. 1. The remaining playouts appear along the same line at spaced intervals. For instance, a second playout of Feature_A occurs in auditorium 100 of FIG. 1 at time 214 after an inter-show time interval 212 following the completion of first playout of that same feature. Similarly, a third playout of Feature_A occurs in the same auditorium at time 218 after an inter-show time interval 216 following the second playout of that feature.

The second line of the first doublet 123 in FIG. 2 corresponds to the published presentation start time schedule for Feature_B in the auditorium 100′ of FIG. 1. As seen in FIG. 2, the published schedule for auditorium 100′ comprises three playouts of Feature_B at times 220, 224, and 228, respectively, the first playout from the start time 202 of Feature_A by an inter-show time interval 221. The second and third playouts of Feature_B, respectively, commence at times 224 and 228 after by inter-show time intervals 222 and 226, respectively.

For purposes of the present principles, the published start time schedule stored in database 122 of FIG. 1 can comprise a list of triplets, each triplet identifying the feature presentation for playout, the auditorium where the playout will occur, and the presentation start time at which playout will begin. The inter-show time intervals 212, 216, 221, 222, and 226, each representing the interval between the completion of the previous playout and the start of the playout of the next scheduled feature presentation, appear in FIG. 2 to make latter discussions more clear. However, the published start time schedule need not explicitly describe such inter-show time intervals because, with knowledge of the start time of each feature presentation and its duration, calculation of the inter-show times becomes straight forward.

In practice, each published presentation start time schedule will identify the feature presentation according to the actual feature contained within it. In other words, a published start time schedule will identify the name of a movie and its corresponding presentation start time. Often, the published presentation start time will not correspond to the start time of the actual feature, but rather, will correspond to the start time which a pre-show presentation undergoes playout. The pre-show presentation comprises auxiliary content, such as advertisements, public service announcements, news, entertainment features, and/or trailers for coming attractions. As a matter of policy, an exhibitor might choose to associate the published presentation start time as the time when the movie trailers begin. For some exhibitors, the published start time corresponds to the start of a fifteen minute entertainment news show followed by one or more trailers.

Given the potential number of variations on this theme, for the purposes of this discussion, the scheduled start time constitutes the effective start time of a “show”, whether that requires a computation of an offset from a published presentation start time due to an exhibitor's policy relating the published presentation start time constituting the actual start of the feature, or the start of the pre-show, or a time at a predetermined interval therebetween.

As discussed previously, the working presentation start time schedule stored in database 112 of FIG. 1 will initially comprise a copy of the published presentation start time schedule stored in the database 122 of FIG. 1. The doublet 113 of FIG. 2 immediately below the doublet 123 graphically illustrates the working presentation start time schedule stored in the database 122 of FIG. 1. Thus, the feature presentations start times 210′, 214′, and 218′ depicted in doublet 113 correspond to the presentation start times 210, 214, and 218, respectively, depicted in doublet 123. Likewise, the presentation start times 220′, 224′, and 228′ depicted in doublet 113 correspond to the presentation start times 220, 224, and 228 depicted in doublet 123. Similarly, the inter-show time intervals 212′, 216′, 221′, 222′, and 226′ depicted in the doublet 113 of FIG. 2 correspond to the inter playout time intervals 212, 216, 221, 222, and 226 depicted in the doublet 123.

Under normal circumstances, playout of the feature presentations proceeds according to the published presentation start schedule. Thus, for each auditorium, playout of the scheduled feature presentations will occur according to working presentation start time schedule in the database 112 of FIG. 1 since, under normal circumstances, the published presentation start time schedule and the working presentation start time schedule will not differ very much if at all. As discussed previously, various conditions can arise which necessitate altering the presentation start time schedule. In accordance with the present principles, there is provided a technique for controlling, (i.e., managing) the presentation start times. The doublets 231, 241, 251, 261, and 281 graphically depict the feature presentation start time schedules for Feature_A and Feature_B, as managed in accordance with the present principles in the event of a disruption, such as a delay 233 between the published start time 202 and the actual play out of the Feature_A in theater 100 of FIG. 1. In particular, each of the doublets 231, 241, 251, 261, and 281 depicts the presentation start time as altered in accordance with a particular management technique for controlling the feature presentation start time. As will become better understood hereinafter, each of the presentation start time control methods depicted by a corresponding one of doublets 231, 241, 251, 261, and 281 individually possess the ability to effectively manage the presentation start times in the event of a delay. Moreover, the individual methods are not mutually exclusive and can be combined without departing from the spirit of the present principles.

The delay 233 arises as a result of a particular auditorium, say auditorium 100 being unavailable for the playout of the first scheduled feature presentation until time 230 as shown in the upper-most line of the doublet 231. For example, the lamp in projector 104 of FIG. 1 might require replacement or the theater 100 might require cleaning because a patron became sick. Alternatively, the theater management might impose a house-wide delay in the event that inclement weather would prevent patrons from arriving on time or if long queue lines currently exist at the concession stand that would require guests to trade-off missing the start of the feature against foregoing the purchase of popcorn and a beverage. Heretofore, theater management addressed such delays by having the projectionist ignore the scheduled presentation start time and manually initiating play out of the feature presentation at a later time. However, it is desirable to avoid such manual intervention. It is also desirable to substantially automate a response to the delay 233, at least with respect to subsequent playouts, if not entirely.

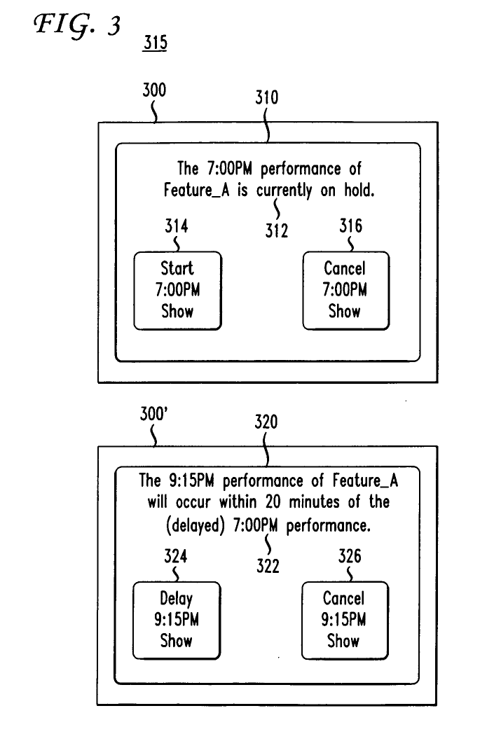

The first method for controlling delay in accordance with the present principles serves to propagate the delay throughout the playout of feature presentations as illustrated in doublet 231 in FIG. 2. As depicted in this doublet, the first playout of Feature_A begins at time 230 after the delay 233. Thus, as compared to the playout of the Feature_A depicted in each of doublets 123 and 113, the playout of Feature_A in doublet 231 begins late. Using the delay propagation method of the present principles, subsequent playouts of Feature_A, which occur at the times 234 and 238 as depicted in doublet 231, likewise become delayed by the same amount as the delay time 233 with respect to the start times 214 and 218 of the published schedule presentation start time schedule depicted in doublet 123 of FIG. 3. Thus, the inter show time intervals 232 and 236 depicted in doublet 231 correspond in length to the scheduled inter-show time intervals 212 and 216, respectively depicted in doublet 123. The delay propagation method has the advantage of maintaining the same inter-show time interval, thus allowing the audience time to depart, the cleaning crew time to clean the auditorium, and the next audience time to be seated. However, this method forces all subsequent audiences attending playouts of the Feature_A in auditorium 100 to suffer the same delay. In contrast to the delayed playouts in auditorium 100 of FIG. 1, playouts of the Feature_B occur in auditorium 100′ at presentation start times 220″, 224″, and 228″, corresponding to the presentation start times 220, 224, and 220 for Feature_B in the published presentation start time schedule depicted in doublet 123. Thus, audiences in auditorium 100′ remain unaffected by the delay 233 associated with the auditorium 100 of FIG. 1.

A second method for controlling the presentation start times, hereinafter referred to as “the shortened inter-show time interval method”, when implemented, yields the presentation start times depicted in doublet 241. As depicted in the upper time line of doublet 241, the first playout of Feature_A begins at time 240 after a delay 233. However, rather than maintain inter-show time intervals between subsequent playouts of the Feature_A constant as depicted in doublet 231 of FIG. 2, the shortened inter-show time interval method of the present principles shortens the inter-show time interval 242 between the next playout of Feature_A at time 244, and, if necessary, shortens the inter-show time interval 246 before the playout of Feature_A at time 248. A particular theater might have a policy that dictates that the inter-show time interval 242 have a minimum duration. For instance, an exhibitor could mandate that not less that 10 minutes exist between the end of a feature presentation and the beginning of the next to allow an audience to clear the auditorium, a cleaning crew to perform its function, and the next audience time to enter.

Further, the minimum length of the shortened inter-show time interval 242, as well as the minimum length of the shortened inter-show time interval 246 can vary depending on the day of the week and the time of the day. For example, during week days, or during a weekend matinee, a 10 minute shortened inter-show time interval might prove acceptable. However, on a Friday or Saturday evening, when audiences are larger, a longer inter-show time interval of say, 30 minutes, might become necessary. In this example, the method of the present principles will set the first shortened inter-show time interval 242 to the minimum value dictated by the predetermined policy with the result that second playout of Feature_A does not occur until the time 244 so at least the audience for the second playout is discomfited by the second playout being late with respect to the published presentation start time 214 depicted in doublet 123. However, by shortening the inter-show time interval 242, playout of Feature_A at the time 240 will precede the playout of Feature_A at time 234 depicted in doublet 231.

Further, if the combined amount by which the inter-show time intervals 242 and 246 have been shortened equals the delay 233, then, the third playout of Feature_A at the time 238 will coincide with the published presentation start time 218 for Feature_A as depicted in doublet 123. In this way, the audience for third playout of Feature_A at the time 238 does not experience any inconvenience from the delay 233. In other words, shortening the inter-show time interval 242 (and the inter-show time interval 246 if necessary) completely mitigates any adverse effect of the delay 233, thus allowing the actual presentation start time for the third playout of Feature_A to coincide with the published presentation start time for this playout. As before, all audiences for auditorium 100′ remain unaffected by the delay 233.

Shortening the inter-show delay 242 (and the inter-show delay 246 if necessary) can present difficulties. For example, the minimum inter-show interval dictated by exhibitor policy might not afford the cleaning crew enough time to perform a thorough job. Moreover, in the event of a larger than expected audience, not all patrons will find their seats before dimming of the house lights and play out of the feature presentation which can prove disruptive.

The doublet 251 depicts the presentation start time times that result from implementation of a third method for controlling presentation start times in accordance with the present principles. As described hereinafter, this method of controlling presentation start time operates to take account of the delay 233 by shortening the actual length of the first playout of Feature_A. Thus, the first playout of Feature_A depicted in doublet 251 will start at time 250 which corresponds to the start time 240 of Feature_A depicted in doublet 241. However, Feature_A depicted in the doublet 251 will end before Feature_A of doublet 241. As discussed previously, each of Feature_A and Feature_B comprises auxiliary content, including one or more of the following: advertisements, entertainment news, teasers, trailers, public service announcements, policies (e.g., ‘Please turn off your cell phone’), interstitials (e.g., ‘Coming Soon to this theater’ immediately before the trailers), in addition to the actual feature. In practice, restrictions imposed by the content provider prevent shortening of the actual feature. The remainder of the show (i.e., the auxiliary content) remains subject to the exhibitor's preference. For example, the exhibitor can decide to show fewer advertisements, eliminate entertainment news and skip teasers etc. As a matter of policy, each piece of content typically has a priority, the highest of which belongs to the actual feature. Within the auxiliary content, paid advertisements will have the highest priority. Shortly before playout of the Feature_A at time 250, execution of a process can occur to shorten the playout of Feature_A, that is, to shorten the show play list which specifies the particular auxiliary content that undergoes play out together with the actual presentation. The shortening of the show play list typically takes account of the priority assigned to each piece of auxiliary content so that the skipping of non-revenue generating advertising will likely occur first before shortening or skipping any advertising.

The shortening of the show playlist executed in connection with the first playout of Feature_A at time 250 depicted in doublet 251 preferably yields a presentation that still retains a level of organization, cohesiveness, and quality in keeping with the exhibitor's policies. Such shortening can occur automatically by codifying and prioritizing a set of rules to represent the exhibitor's policies. In this way, an automatic process can undergo execution to shorten Feature_A sufficiently to mitigate the delay 233 for subsequent playout of this feature at times 254 and 258, corresponding to the published presentation start times 214 and 218, respectively depicted in doublet 123. However the exhibitor's policies or the aggregate length of the maximum priority content might not permit shortening of the Feature_A to allow the first playout to occur such that the start time 250 remains early enough to permit subsequent playouts to coincide with the published presentation start times. Under such circumstances, the Feature_A could undergo shortening prior to the second playout at the time 254 (though with, perhaps different results). Ideally, the subsequent playouts of Feature_A at times 254 and 258 depicted in doublet 251 will approximate more closely, the published presentation start times 214 and 218, respectively, depicted in doublet 123. As illustrated in doublet 251, the third playout of Feature_A at time 258 does coincide with the corresponding published presentation start time 218 depicted in doublet 213. Implementation of the presentation start time control method depicted in doublet 251 does not change the inter-show time intervals 252 and 256 so they remain of the same duration as the corresponding inter-show time intervals 212 and 216, respectively, depicted in doublet 123. As before, the playouts in auditorium 100′ of FIG. 1 remain unaffected by implementing this method in connection with the playouts in auditorium 100 of FIG. 1.

The presentation start time control methods depicted in doublets 231, 241, and 251 can be combined. If the shortened-show length method that generates the presentation start times depicted in doublet 251 were combined with the shortened inter-show time method depicted in doublet 241, then the second playout of Feature_A could coincide with the scheduled playout start time 214 depicted in doublet 123.

In some cases, the staggered start times of shows throughout a theater will make it advantageous to switch the venue in which a show undergoes playout and thereby overcome the delay. Such an auditorium-swap method is depicted by doublet 261 of FIG. 2. Here, the scheduled first playout of Feature_B in auditorium 100′ occurs at the time 220″ before the delayed first playout of Feature_A in auditorium 100 of FIG. 1 at time 260. Thus, if the second playout of Feature_A, originally scheduled for auditorium 100, now occurs in auditorium 100′ of FIG. 1 at time 274 depicted in the doublet 261, then the second playout of Feature_A will coincide with the published presentation start time 214 as depicted in the doublet 123. Note that the inter-show time interval 272 depicted in doublet 261 can be subject to an exhibitor specified policy mandating a minimum time for audience egress, cleaning and new audience seating. The previously scheduled second playout of Feature_B in auditorium 100′ that would have otherwise occurred at the published presentation start time 224 depicted in doublet 123 now occurs in the auditorium 100 at time 264 which coincides with the time 224. The playout of Feature_B in auditorium 100′ at time 264 follows the inter-show time interval 262 after completion of the playout of Feature_A. The inter-show time interval 262 has a duration at least equal to the minimum allowed inter-show time interval as discussed above. In this example, the second playouts of Feature_A and Feature_B occur as originally scheduled; though in swapped auditoriums. This method for controlling playout show time presentations has particular applicability for theaters with systems which can automatically display the names of features over each auditorium's entrance. Thus, if such an auditorium swap occurs in a timely manner (e.g., before inter-show time interval 272 begins), then theater audiences should encounter little confusion by the theater swap. Rarely does a published schedule include the identification of the auditorium in which a feature will be shown.

Referring to the doublet 261, the third playouts of Feature_A and Feature_B at times 278 and 268, respectively, could revert to their originally scheduled auditoriums 100 and 100′, respectively. However in the interest of keeping the inter-show time intervals 266 and 276 as comfortably large and uniform as possible, the remaining playout of Feature_B at time 268 will occur in the auditorium 100 of FIG. 1 and the playout of the Feature_A at time 278 will occur in auditorium 100′ of FIG. 1. If either of the shortened inter-show time intervals 262 or 272 becomes too short, then application of the shortened show length method might become necessary so that the resultant presentation start times coincide with the published presentation start times stored in the database 122 of FIG. 1.

A fifth method for controlling presentation start times entails skipping the playout of a feature presentation as depicted in the doublet 281 of FIG. 2. As seen in the first time line of this doublet, the published first playout of Feature_A, which would have otherwise occurred at time 210 after the delay 233 as seen in doublet 123, has been cancelled in doublet 281. Thus, the auditorium 100 of FIG. 1 remains quiet throughout the inter show time interval 282. Subsequent scheduled playouts of Feature_A scheduled at times 214 and 218, as depicted in doublet 123, occur in a timely manner at times 214″ and 218″ in doublet 281. While the doublet 281 depicts cancellation of the first scheduled playout of Feature_A, a feature presentation elsewhere within the schedule could undergo a cancellation and yield the same effect. For example, if the working presentation start time schedule included a late-night playout that would now run past an exhibitor-mandated closing time because of the delay 233; the theater manager could cancel that scheduled playout. Cancelling a feature presentation generally will result in a loss of revenue to the exhibitor.

The description of the presentation start time control time methods depicted in connection with doublets 231, 241, 251, and 281 in terms of the inter-show delay intervals simplifies the understanding of each method. In practice, implementation of each of these methods only requires modification to the start time of the playout of Feature_A in auditorium 100 of FIG. 1 in accordance with the working presentation start time schedule stored in the database 112 of FIG. 1. (In contrast, the auditorium swap method depicted in doublet 261 involves both theater auditoriums 100 and 100′ of FIG. 1).

In the illustrative embodiment of FIG. 2, the inter-show time intervals constitute artifacts of scheduling two consecutive shows. In some embodiments, computation and clocking of the inter-show time intervals could occur so that the actual start time constitutes an emergent property of the prior show's end time plus the inter-show time interval.

While the goal of on-time performance has been described with respect to the published presentation start time schedule stored in the database 122 of FIG. 1, in practice most presentation start time adjustments occur with respect to the working presentation start time schedule stored in the database 112 of FIG. 1 for several reasons. First, after encountering the delay 233, the working presentation start time schedule in the database 112 undergoes a modification in accordance with one or more of the above control methods to accommodate or mitigate the delay 233. In practice, the rules corresponding to the presentation start time adjustment method discussed with to the of doublets 231, 245, 251, 261 and 281, respectively, resides in a database, such as but not limited to the database 112 of FIG. 1 which stores the working presentation start time schedule. Typically, the theater management system 110 will apply one or more of these rules as discussed, usually automatically, in response to a delay condition to effect adjustment of the presentation start times.

In this regard the working presentation start time schedule can serves as basis used for calculating subsequent schedule changes in the event of a second delay (not shown) causing additional postponements (as well as possible cancellations) of show playouts with respect to the working presentation start time schedule. When accommodating a second delay, the working presentation start time schedule stored in database 112 of FIG. 1 remains the starting point and advantageously can serve as a reference, just as the published presentation start time schedule stored in the database 122 served as the reference upon encountering the delay 233.

When handling a second or later delay (not shown), the application of one or more of the above methods might require decision making based on the originally published presentation start time as well as the current start time as recorded in the database 112 of FIG. 1. In this way, a single playout of a feature does not undergo a step-by-step delay and rescheduling until it occurs many hours after its originally scheduled start time. In a preferred embodiment, each of the above-described presentation start time control methods undergo execution alone or in combination and a utility function evaluates the results in accordance with the exhibitor's policies to determine a best choice. Only the exhibitor or its pre-determined policies can decide whether it is better to delay a particular playout by 20 minutes but keep the same auditoriums, or swap auditoriums and stay on the original schedule. Such an answer typically varies between theaters. For instance, if the auditoriums do not have dynamic signage, or if the auditoriums involved in the swap are far apart and therefore require more personnel to advise audience members of the swap, then swapping the auditoriums becomes less desirable than when the auditoriums have dynamic signage or are close together.

Preferably, the utility function will assign each discomfiture (e.g., delay of 0-5 minutes, delay of 5-10 minutes, swapping between adjacent auditoriums, swapping between non-adjacent auditoriums, short time between playouts in a single auditorium, moderate time between playouts in a single auditorium, lost playout with large audience, lost playout with small audience, etc.) a discrete cost. In this way, summing the cost of the discomfitures can yield the aggregate cost (e.g., the overall adverse impact) of each possible scenario automatically. The presentation start time control method(s) that yield the lowest cost (e.g., the best scenario) get selected and implemented. Alternatively, costs can be determined from a continuous function of a delay, expected audience size, or actual audience size (determined by number of tickets sold).

In an alternative embodiment, the combination of one or more the methods described above for controlling presentation start times can form a predetermined combination of rules, such as:
1) If, as a result of the delay 233 of FIG. 2, the next scheduled playout will not occur for at least 30 minutes later than the published start time, and an empty auditorium exists at the published start time and has a show scheduled to start not sooner than 25 minutes, then an auditorium swap occurs;
2) Apply the propagation delay method for the next playout;
3) If the next scheduled playout will start more than 5 minutes later than the published start time, and the inter-show delay exceeds 25 minutes, then reschedule by shortening the inter-show delay to 25 minutes.
4) If the next scheduled playout will start more than 5 minutes later than the published start time, and the show has more than 10 minutes of trailers and at least one of the trailers has a low priority, then delete the lowest priority trailer and re-compute the effective published presentation start time for the purposes of evaluating delay; (The presentation start time will now occur earlier by because of the deleted trailer.) and
5) If the next scheduled playout will start more than 15 minutes after the published showtime, query the operator to determine whether to cancel that playout for whether the playout should be cancelled.

Rule 4 from the above list re-emphasizes that the presentation start time, as discussed here, corresponds to the time at which the show begins (e.g., playout of the feature presentation), which need not necessary constitute the ‘playout time’. The ‘showtime’, especially as advertised to patrons of the theater, might be a few minutes before the feature presentation begins, whereas the overall show might start, for example, half an hour before that time.

In the alternative, the theater manager can take account of available choices through the user interface 114 of FIG. 1. In response to various conditions, as reflected by status messages, such as those depicted in FIG. 3, the manager can take appropriate actions to make adjustments to the working presentation start time schedule stored in the database 112 of FIG. 1. The sequence of choices related would form a decision tree, well-known in the art.

The above-described rules might not cover every conceivable scenario. Under such circumstances, the user interface 114 will provide one or more dialog displays to a theater operator or other personnel to prompt selection of one of several possible actions. FIG. 3 shows two sample dialog displays 300 and 300′ provided by the user interface 114 of FIG. 1 to display status messages prompting various actions. For example, the dialog display 300 provides a status message 310 to the theater manger indicating that the 7:00 PM showing of Feature_A currently remains on hold. The theater manager can respond by selecting action 314, which will implement starting of the 7:00 PM show, or action 316 to cancel that show.

Preferably, upon selecting an action, the theater manager will receive a confirmation dialog with appropriate warnings (not shown). If the theater manager chooses to cancel an action, then the original status message will re-appear. Otherwise, the theater management system 110 of FIG. 1 will execute the selected action. Typically, the completion of a particular dialog by the theater manager corresponds to implementation of one of the presentation start time control methods discussed previously. For example, the selection of action 316 depicted in FIG. 3 corresponds to the ‘skip delayed show’ method graphically depicted by doublet 281 in FIG. 2. If delays in separate auditoriums simultaneously cause the delay of separate shows, each delay typically will result in a separate dialog display corresponding to the particular delay to which the theater manager will respond by selecting among available actions.

In an alternative implementation, taking the action 314 depicted in FIG. 3 might prompt a decision to take one or more additional actions (not shown) such as “start in x minutes” where different choices exist for x, or a continuous control enables varying the value of x. Upon taking the action 314 to initiate the first playout of Feature_A following the delay 233 in FIG. 2, other decisions might become necessary. For example, the delay 233 could cause the first playout of Feature_A to interfere with the auditorium preparation time required by the theater exhibitor policy. Under such circumstances, the user interface 114 of FIG. 1 will provide a status message, such as the status message 320 depicted in the dialog display 300′ of FIG. 3 to seek a resolution which in this example is not covered by any predetermined policy. The status message 320 indicates that the 9:15 PM performance will occur within 20 minutes of the delayed first presentation of Feature_A. The selection of action 324 will implement the shortened inter-show time method (or the propagate delay method, according to a predetermined exhibitor preference), while action 326 will implement the skip delayed show method just rejected, but now applied to a later playout. In this way, the user interface 114 of FIG. 1 will guide the theater manager or other personnel through a sequence of decisions necessary to select each of the possible actions.

In the illustrative embodiment, the user interface 114 includes a touch screen. Alternatively, theater manager could make use of a computer mouse or keyboard to enter actions in response to status messages displayed on a monitor. Preferably, user interface 114 is portable so that the manager responsible can always have the access needed to manage the theater regardless of the manager's location in the theater. For example, the user interface could take the form of a portable terminal, e.g., a lap top computer or personal data assistant (PDA).

Rather than enter actions through the user interface 114, the theater operator or other personnel such as a projectionist, could accomplish the selected action by directly entering commands to the digital cinema server 102 of FIG. 1 by pressing a play or stop transport control (not shown). For example, a projectionist might enter a command in response to instructions from a manager. By monitoring the status of server 102, the theater management system 110 can detect the play or stop command and infer one of the choices corresponding to actions 314 and 316 respectively.

While only the status messages 310 and 320, and actions 314, 316, 324, and 326 have been discussed, those skilled in the art will appreciate that the user interface 114 of FIG. 1 has the capability of generating a wide variety of possible status messages, each having associated actions. Additional actions can appear separately in a given dialog display. Alternatively, in accordance with theater management preference, additional methods for presentation start time control could be automatically combined into the current action. For example, the action 324 of FIG. 3 also might invoke the shortened show length method, either on the show currently running, assuming content exists that can still be deleted, or on the 9:15 PM show. The latter is preferable because of the relative ease with which a non-running show can undergo editing and because removal of lower priority ads or trailer elements from the 9:15 PM playout might escape notice and would allow the feature presentation to play out substantially on time.

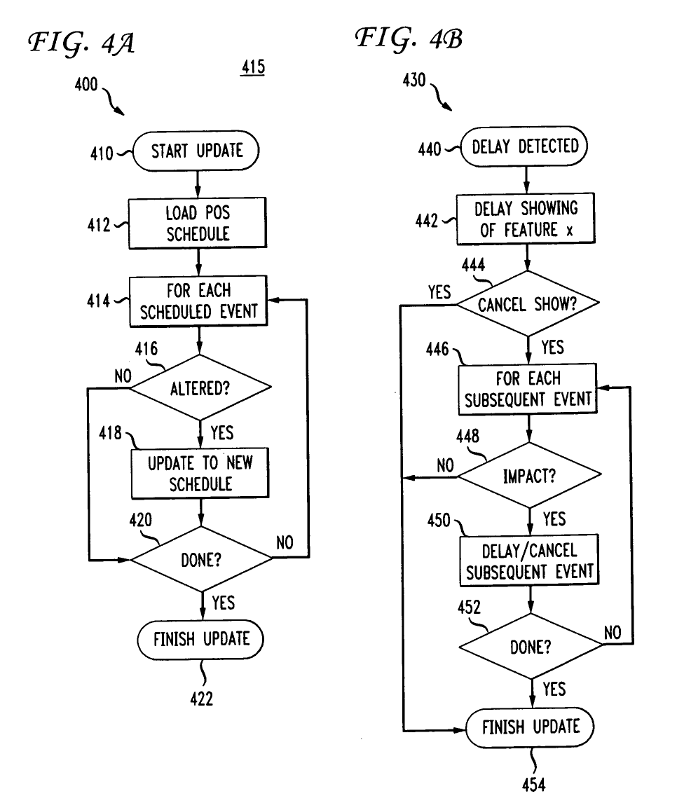

FIG. 4A depicts in flow chart form a process 400 for updating a previously published presentation start time schedule. The process begins upon execution of the start update step 410 whereupon the theater management system 110 of FIG. 1 communicates with the database 122, typically through the point of sale system 120, to obtain the published presentation start time schedule. Alternatively, the theater management system 110 could obtain the published presentation start time schedule through the Internet (not shown) or from a remote server on a WAN (not shown) associated with the theater circuit regional or head office. In a worst case scenario, the theater manager or other personnel could manually enter the published presentation shown time schedule, such as by typing the information obtained by reading the movie times as published in the local paper.

In step 412, the theater management system 110 of FIG. 1 loads the published presentation start time schedule from the database 122 of FIG. 1 and proceeds to parse the data. In a loop beginning at step 414 of FIG. 4 and having an iteration for each event (i.e., playout) listed in the published presentation start time, the theater management system 110 compares the event in step 416 against any substantially matching data in the working schedule stored in the database 112. Upon finding the event to be identical, the theater management system 110 considers the event unaltered so no change is needed. The process continues at step 420.

However, if one or more changes have been made, such as a show has been delayed until later, then an update is undertaken during step 418. In the case where no modifications have been made to the working schedule, or at least in proximity to the altered event, then the update can be taken automatically and propagated into the working schedule. However, in rare circumstances when a conflict exists between an update to the working schedule induced by a delay, which normally occurs on the day of the scheduled event(s) and a change to the published schedule, which normally occurs before the scheduled event(s) then the conflict must be resolved.

As a matter of policy, the user interface system 114 of FIG. 1 will present conflicts one at a time to the theater manager or other personnel. Alternatively, as a matter of policy, a resolution of conflicts generally occurs in favor of the working presentation start time schedule since it is the working presentation start time schedule that records on-site decisions related to schedule alteration. Assuming conflict resolution occurs in favor of the working presentation start time schedule, the point of sale system 120 of FIG. 1 preferably receives updates to the working presentation start time schedule stored in the database 112 so that further ticket printing occurs in accordance with the most current information.

In an alternative embodiment, the database 112 storing the working presentation start time schedule can record delays known in advance (e.g., auditorium 100 remains unavailable until 3 PM because of scheduled maintenance). In this way, automatic updates to the published presentation start time schedule can occur and the working presentation start time schedule can undergo reprocessing. For example, assume that the original published schedule had two performances which now require cancellation due to the maintenance activity. If the updated published presentation start time schedule has at least the later of those two performances shifted to a later time, then when reprocessing the updated published presentation start time schedule, the later performance undergo will undergo playout as published or only slightly delayed due to the maintenance. After updating the working presentation start time schedule during step 418, a check occurs during step 420 to determine whether any more events need evaluation. If so, the loop iterates to step 414. Otherwise the process exits at step 422.

FIG. 4B depicts in flow chart form a process 430 for handling delays that arise after creation of the published presentation start time schedule. The delay handling process 430 begins when a delay, 233 (see FIG. 2), whether actual or anticipated, becomes known during step 440. Detection of a delay triggers initiation of a delay evaluation process during step 442. Following step 442, an evaluation occurs step 444 made whether or not to cancel the delayed playout. If so, the database 112 gets updated and the delay handling process 430 completes during step 454.

Upon deciding during step 444 to continue with the playout of the feature presentation, even though delayed, then the working presentation start time schedule stored in the database 112 undergoes updating to reflect the delay in the corresponding playout. Thereafter, the delay handling process 430 enters a loop at step 446 to propagate the delay. The loop iterates over each event consecutive to the originally scheduled playout event in the working schedule. That is, if an event became substantially delayed so that it overlapped or occurred later than a subsequent event (i.e., the start time sequence has become inverted), the previously consecutive events would be handled in order.

Following step 446, each event in the original sequence following the delayed event undergoes testing during step 448. During such testing, an assessment is made to determine whether any adverse impact exists. If the current event and a delayed playout overlap, then the current event becomes impacted. If, according to the schedule, the delayed playout will end before the current event by too short an inter-show time interval according to exhibition policy, then the event becomes impacted. After detecting that an event has become impacted, handling of the impacted event continues at step 450. If a current event encountered during step 448 does not suffer from any impact as a result of a delayed playout, then the current event and the remainder of the schedule remain valid. Under such circumstances, the delay handling process 430 exits the loop and completes at step 454.

Upon determining during step 448 that event has been impacted, execution of step 450 occurs, resulting in cancellation of that current event, or rescheduling in accordance with one or more of the five presentation start time control method, namely, (a) the propagate delay method as depicted in doublet 231 of FIG. 2, (b) the shortened inter-show time method depicted in doublet 241, (c) the shortened show length method depicted in doublet 251, (d) the auditorium-swap method depicted in doublet 261, and (e) the skipping of a playout method depicted in doublet 281. If the playout is not cancelled using the skip a playout method, then implementation of one or more of the other methods can occur to reschedule the current playout. The choice of which method(s) to implement can be made through a manual decision presented with user interface 114, such as in dialog displays 310 and 320 of FIG. 3. Preferably, the presentation start time control method gets selected automatically using a utility function as described above and the ‘lowest cost’ possibility is selected.

When employing the auditorium swap method depicted in doublet 261 of FIG. 2, potentially two or more subsequent playouts become affected, i.e., the subsequent playouts occurring in each of the two auditoriums. In this circumstance, the order of analysis would preferably proceed first with the playout having the earlier published start time of the two auditoriums, with ties going to the feature presentation having the shorter duration. However, other sequences of analysis would also work and depending on the heuristic, and might offer better results (e.g., less discomfiture.)

After the subsequent event has been rescheduled or cancelled in step 450 of FIG. 4, the working presentation start time schedule undergoes examination for further events during step 452. Upon finding other events, the loop iterates to step 446, otherwise the delay handling process 430 concludes at step 454.

Alternative embodiments of delay handling process 430, although not shown, fall within the scope of the present principles. For instance; multiple different candidate working schedules (not shown) could be generated by executing the loop beginning at step 446, but making different decisions during step 450 for each different candidate. Then, each of the candidate working schedules could undergo evaluation using a utility function, as previously discussed, giving a value for each candidate schedule as a whole, rather than only examining a localized value of the utility function one decision at a time. Such a utility function would yield a global minimum, rather than relying on the pursuit of local minima to achieve an acceptable resulting working schedule. Even in a large multiplex theater, the number of permutations one or more delays can have on a daily show schedule represent a solution space which is quite tractable for complete exploration by such a process when run on the processors of theater management system 110, given the speed of modern computers.

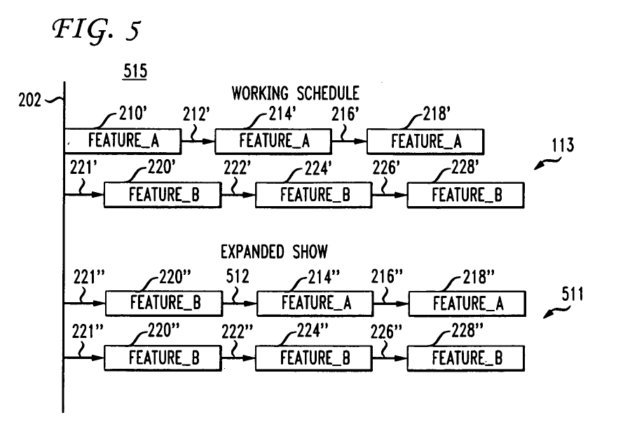

FIG. 5 illustrates another application of the same presentation start time control methods described previously to deal with a disruption caused by excess demand. Frequently, an exhibitor will recognize that the audiences seeking to view a new, unexpectedly, popular movie could far exceed the seating available in the scheduled auditorium(s). In such an event, employing the auditorium swap method can move a more popular feature into an auditorium with a larger seating capacity, by swapping with a less popular feature currently in that auditorium. However, even filling such a larger auditorium to capacity might not suffice to maximize an exhibitor's revenue. Thus, the exhibitor would gain an advantage by cancelling one or more playouts of one or more less popular features and utilize the corresponding freed auditorium for originally scheduled playouts such that playout times of the newly scheduled playouts substantially coincide with the originally scheduled playouts. Doublet 511 of FIG. 5 depicts such an expanded show method. For comparison purposes, the doublet 113, which depicts the times for playout of the Feature_A and Feature_B according to the working schedule, also appears in FIG. 5, with the presentation start times and inter-show time intervals designated with the same references prime, as compared to doublet 113 of FIG. 2.

The presentation feature playout times depicted in doublet 511 of FIG. 5 reflect a determination that the demand for the first playout of Feature_B at time 220″ far exceeds capacity of the scheduled auditorium. By comparison, the demand for the first playout of Feature_A at time 210′ as depicted in doublet 113 of FIG. 5 remains insufficient to warrant expending the auditorium 100 for this feature presentation. Instead, the first playout 220′ of Feature_B undergoes duplication to permit playout of the Feature_B at the time 220″ in both auditoriums 100 and 100′ of FIG. 1. Both start at about the same time after the delay 221″, which substantially coincides the delay 221′ depicted in doublet 113 of FIG. 5. With no further changes, the originally scheduled second playout of Feature_A will occur at time 214″ after inter-show time 512, and the remainder of the schedule remains unchanged.

Repeating the decision to expand the playouts of Feature_B a second and third time occurs by a similar application of the above-described process. The utility function as previously described can include estimates of demand for each scheduled playout. When the value of the estimated demand exceeds a scheduled theater's capacity (which may be derated), and the anticipated revenue gain exceeds the revenue lost for another contemporaneously scheduled feature, then the option to expand the playout of the more popular feature can be offered or automatically taken, depending upon exhibitor policy, in an adapted version of delay handling process 430. In an adapted version of the delay handling process 430, the process would begin at step 440 based on the detection of excess demand for a scheduled playout. In an adapted step 442, a search would occur for an auditorium having a candidate playout with a predicted demand with a sufficiently low value. In step 444 if no suitable candidate is found, the process would conclude by branching to step 454. However, upon finding a candidate, that playout is cancelled and the expanded show is added to the schedule in the selected auditorium and processing continues as before at step 446, with the subsequent events being those previously scheduled in the selected auditorium that had followed the cancelled playout. Depending upon predetermined policy and manual management selection or automatic evaluation of the utility function, in adapted step 442 an auditorium swap (as described in conjunction with doublet 261) may be selected to address the unexpected high demand for Feature_B. Where an auditorium 100 has a larger capacity than auditorium 100′ and merely swapping auditoriums would satisfy the unexpected high demand for Feature_B and thereby result in no immediate show cancellations, use of the auditorium swap method is preferred, though iterations through delay/cancel step 450 may ultimately result in a subsequent cancellation.

Thus, by the use of the presentation start time control technique of the present principles, dynamic modification of the published schedules for playouts in auditoriums can occur with or without manual intervention, in conformance with an exhibitor's policies to improve, if not optimize, the theater-goers experience and/or the exhibitor's revenue, which often coincide.

1. A method of controlling presentation start times of digital cinema feature presentations comprising the steps of
matching a delay condition to at least one of a set of rules specifying performance start time adjustments for the digital cinema presentations for particular delay conditions;
adjusting the presentation start times of the digital cinema presentations in accordance with the at least one rule matching the delay condition and
executing the digital cinema presentations at the adjusted presentation start times.

2. The method according to claim 1 wherein the at least one rule specifies delaying the presentation start times by equal amounts.

3. The method according to claim 1 wherein the at least one rule specifies shortening an inter-show time interval between consecutive digital cinema presentations.

4. The method according to claim 1 wherein the at least one rule specifies deleting a portion of the digital cinema presentation.

5. The method according to claim 4 wherein the deleted portion of the digital cinema presentation has a low priority relative to other portions of the digital cinema presentation.

6. The method according to claim 1 wherein the at least one rule specifies shifting playout of the digital cinema presentation from one venue to at least one other venue.

7. The according to claim 1 further including the step of storing the set of rules specifying performance show time adjustments in a database

8. The method according to claim 1 wherein the matching step occurs automatically in response to the occurrence of a delay condition.

9. The method according to claim 1 wherein:
the matching step further comprises the step of displaying a status message prompting a choice of alternative actions in response to a match the delay condition to the at least one of rules; and
the adjusting step further comprises the step of adjusting the he presentation start times of the digital cinema presentations at least partly in accordance with user selection of one of the alternative actions.

10. A method of controlling presentation start times of digital cinema feature presentations comprising the steps of
evaluating a delay condition in accordance with different rule set, each including at least one rule specifying a performance start time adjustment for the digital cinema presentations;
selecting the rule set whose performance start time adjustment yields least disruption to exhibition of the digital cinema feature presentations;
adjusting the presentation start times of the digital cinema presentations in accordance with the selected rule set; and
executing the digital cinema presentations at the adjusted presentation start times

11. The theater management system according to claim 10 wherein the rule set includes a rule that specifies delaying the presentation start times by equal amounts.

12. The method according to claim 10 wherein the rule set includes a rule that specifies shortening an inter-show time interval between consecutive digital cinema presentations.

13. The method according to claim 10 wherein at the rule set includes a rule that specifies deleting a portion of the digital cinema presentation.

14. The method according to claim 13 wherein the deleted portion of the digital cinema presentation has a low priority relative to other portions of the digital cinema presentation.

15. The method according to claim 10 wherein the rule set includes at least one rule that specifies shifting playout of the digital cinema presentation from one venue to at least one other venue.

16. A digital cinema system, comprising:
a theater management system for (a) matching a delay condition to at least one of a set of rules specifying performance start time adjustments for the digital cinema presentations for particular delay conditions; (b) adjusting the presentation start times of the digital cinema presentations in accordance with the at least one rule matching the delay condition and (c) and initiating execution of the digital cinema presentations at the adjusted presentation start times.

17. The theater management system according to claim 16 wherein the at least one rule specifies delaying the presentation start times by equal amounts.

18. The theater management system according to claim 16 wherein the at least one rule specifies shortening an inter-show time interval between consecutive digital cinema presentations.

19. The theater management system according to claim 16 wherein the at least one rule specifies deleting a portion of the digital cinema presentation.

20. Theater management system according to claim 19 wherein the deleted portion of the digital cinema presentation has a low priority relative to other portions of the digital cinema presentation.

21. The theater management system according to claim 16 wherein the at least one rule specifies shifting playout of the digital cinema presentation from one venue to at least one other venue.

22. The theater management system according to claim 16 further comprising a database for storing the set of rules specifying performance show time adjustments in a database.

23. A method, comprising the steps of
determining if demand for a given digital cinema presentation exceeds available capacity of an originally assigned exhibition venue; and if so,
selecting a new exhibition venue for the given digital cinema presentation based on demand;
adjusting the presentation start time of the given digital cinema presentation and other subsequently scheduled digital cinema presentations for the new venue; and
executing the digital cinema presentations at the new venue at the adjusted presentation start times.

24. The method according to claim 23 wherein the executing step further comprises executing the given digital cinema presentation at both the originally assigned venue and the new venue.

25. The method according to claim 23 wherein the adjusting step further comprises the step of adjusting the presentation start time of the given digital cinema presentation to substantially coincide with the presentation start time of the given digital cinema presentation at the originally assigned venue.
